(19) United States
(12) Patent Application Publication
(10) Pub. No.: US 2012/0222745 A1
(43) Pub. Date: Sep. 6, 2012

(54) CONTROLLABLE PNEUMATIC BRAKE BOOSTER AND METHOD FOR OPERATING IT

(76) Inventor: Jens Kolarsky, Bietigheim/Bissingen (DE)

(21) Appl. No.: 13/395,337

(22) PCT Filed: Jan. 25, 2011
(86) PCT No.: PCT/EP11/50933

§ 371 Date: May 22, 2012

(30) Foreign Application Priority Data
Jan. 29, 2010 (DE) 102010001355.2
Apr. 15, 2010 (DE) 102010027798.3

(51) Int. Cl. F17D 3/00; F15B 13/04

(52) U.S. Cl. 137/1; 91/418

(57) ABSTRACT

A vacuum brake booster which applies a supporting force to a main cylinder, as well as a method for its operation are described. The supporting force of the vacuum brake booster is able to be set via an adjusting device as well as via a main control valve. Consequently, the brake booster is operable in two operating modes, in a first operating mode, the supporting force being set by the adjusting device, and in a second operating mode, by the main control valve. Among other things, the brake booster is able to be used in brake systems in which the braking effect of a hydraulic and an additional brake system are combined, the braking effect of the hydraulic brake system having to be adapted to that of the additional brake system, for instance, in the case of regenerative brake systems of an electric or an hybrid vehicle.

### BACKGROUND INFORMATION

In brake systems of a vehicle, for the deceleration of the vehicle by the vehicle's driver, pressure is built up in a brake circuit via a main cylinder. To support the driver, a brake booster is able to apply an additional supporting force, if necessary. One possible specific embodiment of such a brake booster is a vacuum brake booster, as is described, for instance, in ‘Kraftfahrtechnisches Taschenbuch’ (Automotive Handbook) (25th edition, BOSCH, Vieweg Verlag ISBN 3528238763, pages 805806). An active pneumatic brake booster is also described in ‘Handbuch Fahrerassistenzsysteme’ (Handbook of Driver Assistance Systems) (2009, Vieweg+Teubner Verlag ISBN 9783834802873). This brake booster is electrically controllable, independently of the driver. In such a brake booster, the poppet valve is operated using an electrically operated magnetic drive.

### SUMMARY

The present invention relates to a vacuum brake booster and a method for operating the vacuum brake booster. The supporting force of the vacuum brake booster according to the present invention is able to be set using a main control valve as well as an adjusting device.

An example brake booster according to the present invention applies a supporting force to a main cylinder. The supporting force is able to be set using a main control valve. When the supporting force is set using the main control valve, the brake booster is in a second operating mode. The supporting force may also be set using an adjusting device, and then the brake booster is in a first operating mode. Because of the possibility of setting the supporting force both by using the main control valve and by using the adjusting device, it is possible to operate the brake booster in the second operating mode, with the aid of a characteristic specified by the geometry and/or the structural design of the brake booster, whereas in the first operating mode this characteristic is able to be set/adjusted by the adjusting device. The booster characteristic, in this context, is no longer only a function of the geometry of the brake booster. By characteristic of the brake booster, one may understand, in this instance, the relationship of the actuating travel of the brake pedal and the supporting force applied by the brake booster, or the relationship of driver force and supporting force of the brake booster at an actuating travel specified by the driver. Because the supporting force of the brake booster is able to be set by the adjusting device, and not only via the main control valve, it is advantageously possible to use the brake booster in brake systems in which the braking effect of an hydraulic brake system, in which the brake pressure is able to be boosted by the brake booster, among other things, has to be adjusted to the braking effect of an additional brake system. Such a brake system is, for instance, a brake system of a hybrid or an electric vehicle, which besides an hydraulic brake system includes an additional, regenerative brake system. If, for example, one reduces the supporting force of the vacuum brake booster corresponding to the regenerative braking effect applied, this results in a reduction in the using up of the brake booster—the wear of the components used being reduced.

The possibility also exists of actively controlling the brake booster via the adjusting device, for instance, for functions such as windshield wipers or prefilling wheel brakes. Because the supporting force of the brake booster is able to be set by the adjusting device and via the main control valve, a fallback level is advantageously present if the adjusting device fails. This fallback level then corresponds to the operating mode of a regular vacuum brake booster. The example vacuum brake booster according to the present invention has the advantage that a supporting force is able to be set at low electrical power input, since current is only applied to the valves in order to set the supporting force.

Thus, it is provided that one connect the adjusting device in an advantageous manner pneumatically to a first chamber of the brake booster. It is also provided that one connect the adjusting device pneumatically to the main control valve of the vacuum brake booster. In this way, it is possible to ventilate the first chamber of the brake booster via the adjusting device, and thus to set the supporting force, as was provided in the first operating mode. The first chamber may also be ventilated via the pneumatic connection between the main control valve and the adjusting device, only, in this case, via the main control valve.

In an advantageous embodiment, the adjusting device is pneumatically connected to a second chamber and to a vacuum source of the brake booster. Because the adjusting device is also connected to the first chamber of the brake booster, the air supplied to the first chamber is also able to be removed again and conducted to the second chamber and/or to the vacuum source. As was described above, by using the adjusting device, in an advantageous manner by ventilating the first chamber, a supporting force of the brake booster is able to be set, in particular, increased. Because of the additional connection to the vacuum source and/or the second chamber of the brake booster, the supporting force of the brake booster is now also able to be reduced by ventilation using the adjusting device.

Furthermore, it is provided that the adjusting device has a first interrupting element for interrupting the pneumatic connection of the adjusting device to the surroundings and a second interrupting element for interrupting the pneumatic connection between the adjusting device and the main control valve. These first and second interrupting elements are able to be provided in the form of valves. The valves are controllable and may thus be controlled in such a way that the pneumatic connections between the adjusting device and the main control valve, as well as between the adjusting device and the first chamber, correspond to the necessary valve settings in the first and second operating mode.

In one advantageous refinement, the first interrupting element is a valve that is closed when current and continuously adjustable, and the second interrupting element is a switching valve that is open when currentless. In the following text, the first interrupting means is also denoted as control valve and the second interrupting means as disconnecting valve.

In the advantageous embodiment, the first chamber of the brake booster is connected to the adjusting device, which, in turn, is connected to the second chamber of the brake booster. For this purpose, it is provided that the adjusting device has a third interrupting element. The third interrupting element enables the interrupting of the pneumatic connection of the second chamber of the brake booster to the adjusting device. A pneumatic feed over in response to the ventilation, that is, an undesired connection to the vacuum source and/or the second chamber of the brake booster is able to be prevented by the third interrupting means. The third valve is advantageously a currentless closed valve. It is particularly advantageous if the currentless closed valve is a continuously adjustable valve. Because of the continuously adjustable valve, the first chamber is able to be ventilated in a controlled manner.

In one advantageous embodiment the vacuum brake booster according to the present invention has a first element for determining a position of an input element for taking up an operating force applied by the driver as well as a second element for determining a position of a booster element with respect to a housing of the vacuum brake booster. A driver mostly specifies a braking command by actuating a pedal or lever. In the brake booster according to the present invention, this leads to a shifting of the input element, that is, to a change of position of the input element. Starting from the at rest position of the input element, the change in position corresponds to the absolute path or even the actuating path of the input element. In order to determine this actuating path, the first element is provided in the form of a position sensor in the brake booster according to the present invention. In a similar way, a displacement path of the booster element with respect to the housing of the brake booster is able to be determined using an additional position sensor. With the aid of signals from these position sensors, one is able to determine the relative deflection of the input element and the booster element with respect to each other. The relative deflection between the booster element and the input rod is a variable via which the boosting ratio, that is, the ratio of supporting force and initial force of the driver is able to be set.

In one alternative embodiment, the relative deflection of input element and booster element may also be ascertained directly via a difference path sensor.

In one refinement of the brake booster according to the present invention, a differential pressure sensor may be provided, using which, the pressure difference between the first and the second chamber of the brake booster is able to be ascertained. This variable, too, may be drawn upon for setting the supporting force.

Furthermore, it is provided that the supporting force of the brake booster is set via a control unit (14), which controls at least the first (6) and the second (7) interrupting elements, particularly while using signals of the first (8) and the second (9) elements for determining the position of the input element and the booster element and/or the elements for determining the relative deflection and/or the elements (12) for determining the differential pressure. In this way, in the first and second operating mode, the position of the valves of the adjusting device can be adjusted to the operating mode, and by the control of the control valve of the adjusting device, the supporting force may be set in the first operating mode. For this purpose, in the control unit, signals of the position sensors or of the differential path sensor and/or of the differential pressure sensor are drawn upon for the control.

In a further advantageous specific embodiment, the control unit controls the first, the second and third valves in order to aerate and/or ventilate the appropriate chambers of the brake booster. Consequently, by controlling the appropriate valves, the pneumatic path relevant to the current driving situation is always open or closed.

According to an example method according to the present invention, it is provided that the supporting force of the brake booster, in the first operating mode, is set by producing a pneumatic connection between the surroundings and the adjusting device at interrupted pneumatic connection between the adjusting device and the main control valve. Since the main control valve, in the example method according to the present invention, is only connected, or able to be connected to the surroundings via the adjusting device, the main control valve is separated from the surroundings by the interruption of the pneumatic connection to the adjusting device. In one pneumatic brake booster, one chamber of the brake booster is, generally, supplied with surrounding air via the main control valve, and thus a pressure difference is set between a first and a second chamber of the pneumatic brake booster, and with that, also a supporting force. If this main control valve is suspended by interrupting the pneumatic connection, it is no longer able to contribute to the setting. Consequently, it is now possible to set the supporting force by the adjusting device. Because of that, as was explained above, the operation of the brake booster is possible using a characteristic that is not, or rather not only, specified by the geometry or the structural execution of the brake booster.

In the example method according to the present invention it is provided that the pneumatic connection between the adjusting device and the main control valve or the surroundings is produced or interrupted by the control of the control valve or the disconnecting valve. Since the control valve is a continuously adjustable valve, not only two valve positions are possible, namely open and closed, but the valve is also able to be controlled in such a way that it moves into an intermediate position.

In the example method according to the present invention, it is provided in a further specific embodiment that the supporting force, applied at interrupted pneumatic connection between the adjusting device and the main control valve of the brake booster, is set by producing fitting pneumatic connections. In this context, the pneumatic connection between the surroundings and the adjusting device is produced, and thus the first chamber of the brake booster is ventilated. This causes a setting of the supporting force in the sense of a buildup of the supporting force. Moreover, a pneumatic connection is produced, between the adjusting device and the second chamber of the brake booster and/or the vacuum source, when the supporting force is to be reduced by deaerating. Based on the fact that the connection to the main control valve is interrupted, it is ensured that the supporting force is set, or is able to be set independently of the driver. The producing and/or interrupting of the pneumatic connection takes place by the control of the first, second and third interrupting means.

Furthermore, it is provided that the relationship between supporting force that is to be set and the position of the input element can be specified. This may particularly be done in the form of at least one characteristic curve, which is stored in the control unit of the brake booster. By providing a characteristic line in the control unit, it now becomes possible to set the characteristic of the brake booster on the part of a software. It is also possible for the driver to select a fitting characteristic line of the brake booster, in order to adapt the braking response to the condition of the surroundings, such as the outside temperature, the operating temperature of the brakes or the brake system, a desired manner of driving, or the driving situation. It is also possible that the characteristic line is stored for additional variables, which are either a function of the variables named or represent the characteristic of the brake booster. Of course, in that case, appropriate sensors will then have to be provided in the brake system, if necessary.

In the second operating mode it is provided that the supporting force of the brake booster is set only by the actuation of the main control valve. For this purpose, it is provided that the disconnecting valve as well as the control valve of the adjusting device not have current applied to them. In this way, the brake booster is able to be operated in the usual manner, which represents a fallback level in the case of current failure or a defect in the adjusting device. According to the additional specific embodiment, the third interrupting element of the adjusting device, that is, the valve which connects the adjusting device to the second chamber and/or the vacuum source, for deaerating the first chamber, is also closed in the currentless state. Consequently, in this specific embodiment, too, the usual operation of the pneumatic brake booster is possible.

In still another specific embodiment of the method, according to the present invention, it is provided that the vacuum brake booster is operated as a part of a hydraulic brake system, which is a part of the overall brake system. The overall brake system, in this instance, has an additional brake subsystem besides the hydraulic brake subsystem. In the example method according to the present invention it is provided that one should set or adapt the supporting force of the vacuum brake booster, and thus adapt the braking effect of the hydraulic brake subsystem to a change in the braking effect of the additional brake subsystem.

### BRIEF DESCRIPTION OF THE DRAWINGS

FIG. 1 shows a schematic representation of an hydraulic brake system of a motor vehicle, in which the brake booster according to the present invention is able to be operated.

FIG. 2 shows a second embodiment of the present invention.

FIG. 3 shows a third embodiment of the present invention.

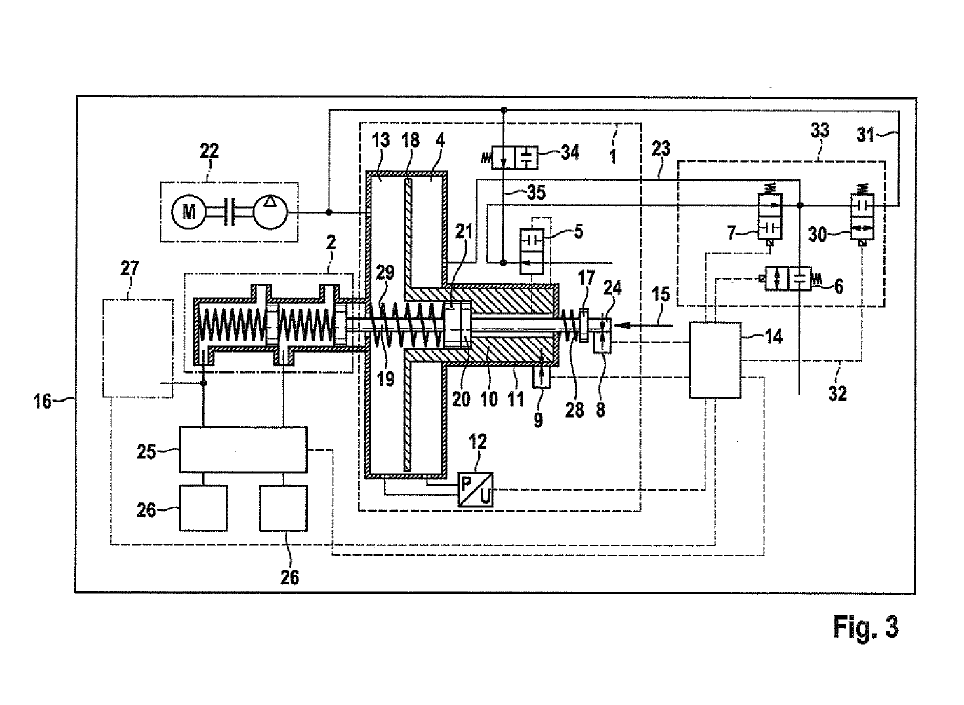

### DETAILED DESCRIPTION OF EXAMPLE EMBODIMENTS

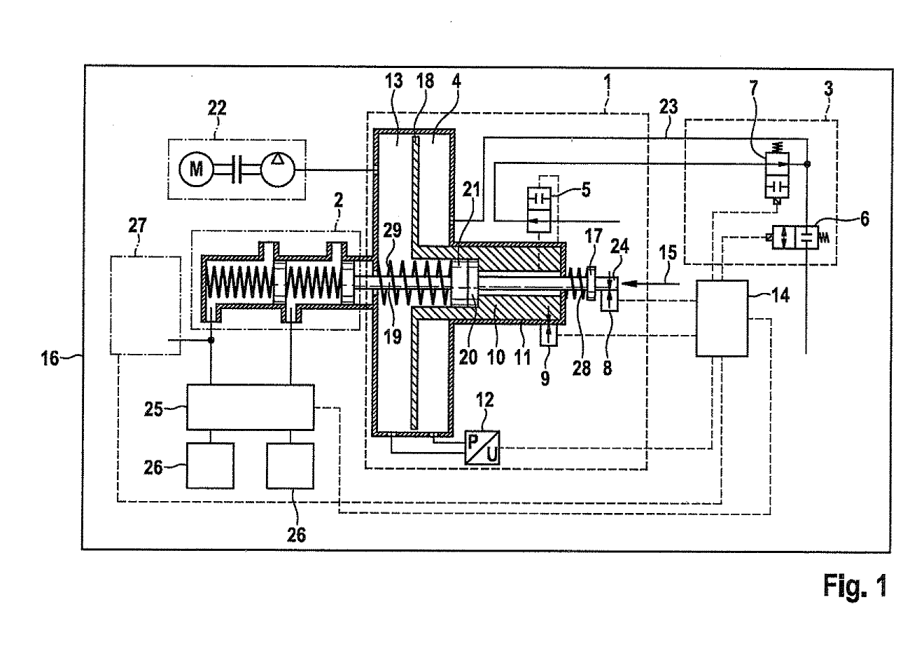

The present invention is shown in exemplary fashion on a hydraulic brake subsystem of an overall brake system. Besides the hydraulic brake subsystem, the overall brake system may have an additional brake subsystem, for instance, a regenerative brake subsystem. Hydraulic brake subsystem 16, shown in FIG. 1, includes a pneumatic brake booster 1, a main brake cylinder 2, a control unit 14, an adjusting device 3 and a vacuum source 22. An ESP hydraulic assembly 25 is sketched in, as well as pressurevolume elements 26 which in this case stand in for the wheel brakes, inclusive of brake lines present in the vehicle. We shall not go into further detail on the type of ESP device 25 and wheel brakes 26. Different brake circuit subdivisions and different embodiments of the hydraulic assembly, for instance, having antilock functions, are possible. Main cylinder 2 may have actuating force applied to it by the driver and/or brake booster 1. Because of that, the pistons of the main brake cylinder shift and bring volumes of brake fluid into the connected brake circuits, which leads to increased pressure in the wheel brake cylinders, and thus to a braking effect for the vehicle. In this context, the pressure distribution in the brake circuits is able to be modulated/specified in a known way by the ESP hydraulic assembly. Furthermore, the hydraulic brake subsystem may have an adjusting device 27, which is in a position, if necessary independently of the driver, to remove volume of brake fluid from the brake system and/or or add to it. Such an adjusting device may be made up, for instance, of a piston having a cylinder, a transmission for the piston and a motor.

A pneumatic brake booster 1, as shown schematically in FIG. 1, is made up generally of a booster housing 11 which has a first chamber 4 and a second chamber 13. Chambers 4 and 13 are separated from each other by a movable diaphragm 18. A booster element 10 is attached to this diaphragm 18. Using this booster element 10, a piston rod 19, via a reaction disk 20 and a guidance part 21, is able to have applied to it a supporting force for actuating a main brake cylinder 2. In this instance, main brake cylinder 2 is drawn in as an in tandem main brake cylinder, which should not be understood to be a restriction on the present invention. Between guidance part 21 and the main brake cylinder, an elastic element is installed, a compression spring 29, for example. This compression spring encloses piston rod 19. The compression spring is used to restore guidance part 21 and, connected to this, piston rod 19.

Second chamber 13 has a pneumatic connection to a vacuum source 22, shown in FIG. 1 as a vacuum pump. Alternatively, a connection to a manifold of an Otto engine may also be provided. First chamber 4 is connected to adjusting device 3 via a pneumatic connection 23, and, via the latter, to the surrounding air. The connection to the surrounding air is able to be interrupted via adjusting device 3. For this purpose, adjusting device 3 has a currentless closed, continuously adjustable control valve 6. This control valve is controlled by a control unit 14. Between first chamber 4 and control valve 6, pneumatic connection 23 branches, and connects the first chamber to a main control valve 5 of the brake booster, via currentless open disconnecting valve 7. Disconnecting valve 7 is also controllable by control unit 14. In the passage position of valves 7 and 5, the first chamber may also be connected to the surrounding air, via the branching of pneumatic connection 23, disconnecting valve 7 and main control valve 5. In pneumatic brake boosters, in the nonactuated state, first chamber 4 and second chamber 13 are both at the same pressure level, mostly at the vacuum level of chamber 13.

Because of the connection of first chamber 4 to the surrounding air, either via control valve 6 or via main control valve 5, surrounding air flows into first chamber 4, and a higher pressure sets in. Based on the pressure difference thus created between first chamber 4 and second chamber 13, a force acts upon diaphragm 18, or, putting it more precisely, upon a separating wall that is not shown here. This force causes booster element 10, that is connected to the diaphragm, to move in the direction of main brake cylinder 2, and thus applies the supporting force, already mentioned, for actuating the vehicle brakes. In this way, the force of brake booster 1 is introduced into the hydraulic brake system. The pressure set in first chamber 4 is able to be coupled, in this context, to the braking specification of the driver. For this purpose, main control valve 5 may be opened by the driver by his specifying a relative deflection of an input rod 24 compared to booster element 10. One part of the main control valve may be displaced using input rod 24, which leads to an opening of the valve. By contrast, a second part of main control valve 5 is connected to booster element 10 and/or to diaphragm 18, and moves along with them.

The pneumatic brake booster, as was described above, may now be operated in two operating modes. In the mechanical mode, the brake booster is operated like a conventional pneumatic brake booster, in which the supporting force of the brake booster is set using main control valve 5. ‘Mechanical’ refers to the opening of main control valve 5 by the driver, by displacing input rod 24 with respect to booster element 10. Because of open main control valve 5, surrounding air flows into first chamber 4. As was described, diaphragm 18 is displaced thereby, and booster element 10, that is connected to it, is displaced in the direction of motion of input rod 24. Main control valve 5 closes as soon as the desired force equilibrium is reached. Between input rod 24 and elastic element 20 a leeway may be provided. In the actuating situation of the brake booster shown in FIG. 1, this leeway is overcome. As long as this leeway is not overcome, no force transfer takes place of the actuating force applied by the driver to the elastic element. In this case, the driver only kicks a restoring spring 28 and the valve, if necessary. On the other hand, if the leeway is overcome, for instance, by an appropriate, perhaps controlled motion of booster element 10, or deformation of reaction disk 20, the driver, in addition to the supporting force of the brake booster, applies a force for actuating the main brake cylinder.

In the controlled operating mode, the brake booster is able to be operated using adjusting device 3. In this controlled operating mode, the main control valve is brought to a standstill by adjusting device 3, in that disconnecting valve 7 is controlled by control unit 14 so that it is closed. Consequently, no more surrounding air is able to reach first chamber 4 via main control valve 5 or via disconnecting valve 7. The supply of surrounding air now takes place via control valve 6, which is controlled by the control unit. Since the control valve is a continuously adjustable valve, not only two valve positions are possible, namely open and closed, but the valve is also able to be controlled in such a way that it moves into an intermediate position. The supply of air may also be carried out using a switching valve. The supply quantity may be set, both in the case of a continuously adjustable control valve, and in the case of a switching valve, by the control of the respective valve used. By control, one might think, in this connection, particularly of a control protocol, which specifies the duration and the valve setting. Such a controlled supplying of air enables a control of the brake booster, both dependent on and independent of the driver.

Consequently, the braking effect is able to be caused by the brake booster and/or by the driver.

For the control of brake booster 1 in the controlled operating mode, using adjusting device 3, signals are supplied by sensors to control unit 14. A first sensor unit 8 ascertains the actuating path of input element 24. A variable may also be ascertained which represents the actuating path of input element 24.

Furthermore, a sensor unit 9 is provided, which ascertains the displacement path of booster element 10 compared to booster housing 11 or a variable representing the displacement path.

The signals of sensor units 9 and 10 may be combined, and thus the relative deflection of input rod 24 and booster element 10 may be ascertained. In the same way, a differential path sensor (not shown) may be provided for the determination of the relative deflection.

Moreover, a sensor unit may be provided which determines the differential pressure between first chamber 4 and second chamber 13 or a variable representing the differential pressure. The differential pressure may also be ascertained by two pressure sensors which ascertain the pressure in each chamber separately.

Elastic element 20, and with that, guidance part 21, is not only able to be acted upon with a supporting force by brake booster 1, but the driver is also able to have the elastic element using an actuating force 15. To do this, however, the abovementioned leeway has to be overcome. By controlling the brake booster, it may be set when the leeway is to be overcome. This may be provided as of a certain leeway, or as of a certain pressure in the hydraulic brake system, and additional points for setting the leeway are possible.

Operating the brake booster using the adjusting device now takes place as follows. The driver applies an operating force 15 and displaces input element 24. This signals the braking command of the driver. The relative deflection may be ascertained using the sensor units described above. The relative deflection leads to an opening of main control valve 5. In the controlled operating mode, control unit 14 controls the disconnecting valve so that it is closed. Main control valve 5 thus no longer has any function. The relative deflection ascertained of input rod 24 and booster element 10 is drawn upon by control unit 14 to control the brake booster. Optionally, or in addition, if necessary, the signals of differential pressure sensor 12 may be drawn upon. While using these signals, control unit 14 controls adjusting device 3, or, more accurately, control valve 6 and disconnecting valve 7. In order to apply a supporting force by the brake booster, control valve 6 is controlled by the control unit in such a way that it opens, and a connection is produced between the surrounding air and first chamber 4. In particular, the control valve is opened continuously. However, a pulsed opening is also possible. The pressure in first chamber 4 is able to be set by the type of opening, particularly by the duration. The supporting force of the brake booster now results from the pressure difference between first chamber 4 and second chamber 13.

The supporting force of the brake booster may be set in this manner independently of the driver. The connection between the driver's braking command, specified by the position of the pedal, and consequently by the displacement path of input element 24 and the supporting force that has been set is able to be freely established. Similarly, the leeway is able to be set via the control of the brake booster. The control of adjusting device 3 is able to take place using characteristic lines, which are stored in control unit 14. For example, the relationship between the pressure to be set in first chamber 4 and relative deflection 14 may be stored. The characteristic of the brake booster is thus able to be set using software.

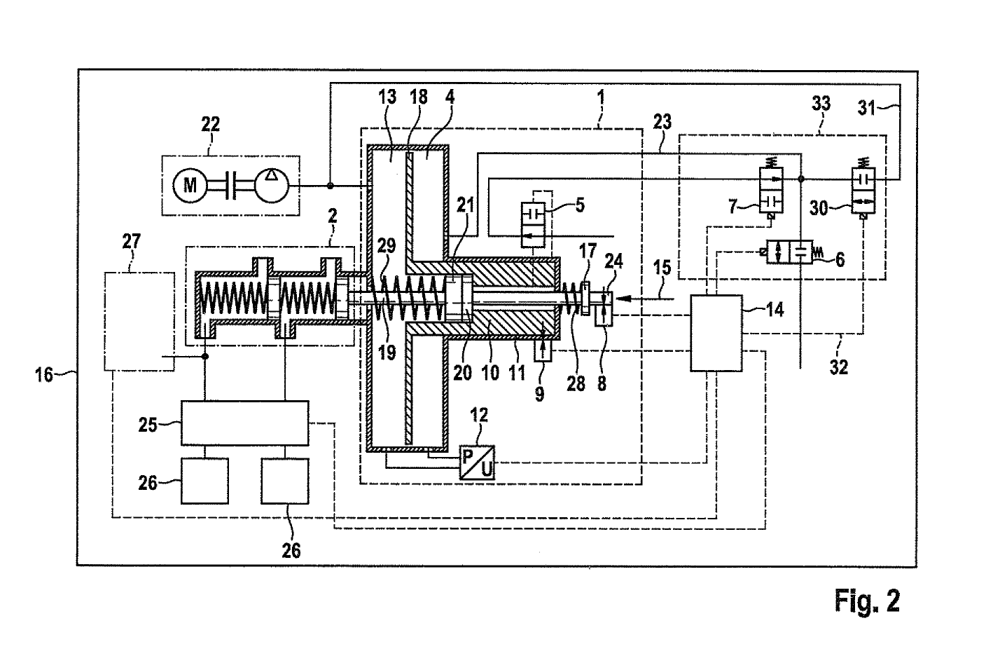

In a further embodiment, as shown in FIG. 2, brake booster 1 may be connected to an adjusting device 33, which has a second control valve 30, besides valves 6 and 7, which were shown in FIG. 1. Second control valve 30 is connected via a pneumatic connection to second chamber 13 of brake booster 1. It is also connected to control valve 6 and disconnecting valve 7. Second control valve 30 is a currentless closed valve, particularly a currentless closed, continuously adjustable valve 30. The supporting force of brake booster 1 is able to be reduced using second control valve 30. To do this, second control valve 30 is opened during closed disconnecting valve 7 and closed control valve 6. Consequently, first chamber 4 gets into pneumatic connection with second chamber 13 via line 31. In this context, pneumatic connection 31 may be coupled directly to brake booster 1, but it is also possible that line 31 opens out into a connecting line between vacuum source 22 and second chamber 13 of brake booster 1. By producing this connection via pneumatic line 31, first chamber 4 may be deaerated either into second chamber 13 and/or via vacuum source 22. Because the pressure difference between first chamber 4 and second chamber 13 therefore goes down, the supporting force of brake booster 1 is thereby reduced. As was explained concerning the control of the remaining valves, the control of second control valve 30 is able to take place via control unit 14. For this purpose, second control valve 30 may be connected to control unit 14 via a data/signal line. The opening of second control valve 30 may take place in many different ways. Thus, on the one hand, it may be provided that control valve 30 should be continuously open, and on the other hand, the opening may take place in pulsed fashion. The degree of opening of the continuously adjustable control valve may similarly be selected to be fitting, so as to set the outflow of the deaeration. In this context, the deaeration may take place, for example, until the desired pressure difference between first chamber 4 and second chamber 13 is reached. In the case of the deaeration, it may be provided that vacuum pump 22 is not operated, and the deaeration first takes place into second chamber 13. For complete deaeration, the vacuum pump may also be operated again. Similarly, it is possible, however, that one should operate the vacuum pump permanently, and thus to deaerate directly via vacuum source 22.

By providing second control valve 30 in adjusting device 33 for deaerating first chamber 4, it is now also possible to have a specific/controlled deaeration, and thus a controlled supporting force reduction. The possibility, especially independently of the driver, of increasing as well as decreasing the supporting force may be very meaningful during the operation of a regenerative brake system, as will be shown below. Complete deaeration of first chamber 4, for instance, after an ended braking, is also possible.

In one specific embodiment that is now shown, adjusting device 3 may also be connected pneumatically directly to the vacuum source, or also to second chamber 13 of the brake booster. The opening out of line 31 into the connection of vacuum source 22 and second chamber 13 is not absolutely required.

In the nonactuated state, both first chamber 4 and second chamber 13 of the brake booster have to be in the deaerated state. This may be ensured by a mechanism, not drawn in in FIGS. 1 and 2, which assures that first chamber 4 of the brake booster gets connected to the vacuum source. Such a mechanism and this functionality may be integrated into a control valve of the brake booster, for example. Similarly, an additional disconnecting valve 34 may be provided, as in an additional specific embodiment based on the specific embodiment shown in FIG. 2. This additional exemplary embodiment is shown in Table 3. The manner of connection of disconnecting valve 34 is able to be transferred without restriction to the first specific embodiment of FIG. 1, and is not shown in greater detail for this reason. But in this case, an additional connection has to be provided for vacuum source 22 and/or for second chamber 13.

Via one pneumatic connection 35, disconnecting valve 34 is connected to main control valve 5 as well as to adjusting device 33, or to adjusting device 3 in the first specific embodiment. In this context, connection 35 opens out into valve 7 as far as the adjusting device is concerned.

Disconnecting valve 34 is a currentless opened switching valve. Besides that, disconnecting valve 34 is pneumatically connected to line 31, or rather to the additional connection, just named, in the first specific embodiment. Using disconnecting valve 34, an interruptable connection is able to be implemented of vacuum supply 22 and first chamber 4. This connection takes place via currentless open disconnecting valve 7. Valve 34 is closed mechanically via the brake pedal, upon actuation of brake booster.

During operation of the brake for carrying out a braking process, valve 34 is first actuated, and the connection to vacuum supply 34 is thus interrupted. Then the first chamber is aerated, either via main control valve 5 or, as was explained above, via adjusting device 3 or 33. A differential pressure is created thereby, which produces the supporting force of brake booster 1.

In addition to the deaeration of first chamber 4 via disconnecting valve 34 in the nonactuated state of brake booster 1, disconnecting valve 34 provides protection in case of a leakage of main control valve 5 or of control valve 6. If there should be an unintended air inflow at control valve 6 and/or at main control valve 5, this could lead to unintended braking. One may counter an unintended deaeration of first chamber 4, using the vacuum source. The connection of valve 5 and/or valve 6, affected by the leakage, to the vacuum source may take place only via valve 35, or additionally via disconnecting valve 7.

Similarly, it is possible, in the second specific embodiment, to ensure the protection from leakage of main control valve 5 or of control valve 6 via valve 30 and line 31. However, in that case, valve 30 has to be controlled by the control unit, since valve 30 is a currentless closed valve. The connection from the first chamber to vacuum supply 22 goes via line 23.

In general, a connection of main control valve 5 and of control valve 6 to vacuum supply 22 is possible both via valve 30 and valve 34, as well as via both valves at the same time.

Because of the possibility of setting the supporting force of the brake booster via adjusting device 3, the brake booster 1 may be used in an overall brake system which, besides the hydraulic brake system includes an additional brake system such as a regenerative brake subsystem. When the proportion of the regenerative brake subsystem of the overall braking effect changes, the braking effect of the hydraulic brake system has to be adjusted to the change, particularly to the braking effect of the regenerative brake subsystem that is present after the change. For this purpose, the supporting force of the brake booster is able to be reduced or increased by the adjusting device, so as to adjust the braking effect. The pressure change in the hydraulic brake system, resulting from the reduction of the supporting force, may lead to input element 24, and consequently the brake pedal, being displaced. To prevent such a displacement, volume of brake fluid may be taken from and/or added to the brake system, using adjusting device 27, that was mentioned at the outset, the displacement of the input element thus being prevented.

In the case of a failure of the current supply of the vehicle or of the control unit/adjusting device, the brake booster is able to operate regularly again in the mechanical operating mode. This is ensured by currentless opened disconnecting valve 7 and currentless closed control valve 6. In the additional specific embodiment, because of currentless closed second control valve 30, there is also the possibility of actuating the brake booster mechanically, in the accustomed manner, without the adjusting device.

The abovementioned operating modes do not exclude each during the course of one braking. It is possible to line up the operating modes one after the other, for instance, first, at low brake pressure, one may brake in the usual way, that is, in the second operating mode, and only then switch over to the controlled operating mode, and vice versa. Because of that, a booster element characteristic line is implementable, which is very variable. An overlapping of the operating modes is also possible, in the case where no complete decoupling of main control valve 5 by disconnecting valve 7 takes place. Consequently, the first chamber of the brake booster is able to be aerated both via control valve 6 and via main control valve 5. In this case, disconnecting valve 7 would, however, have to be provided as a continuously adjustable valve.

It is also possible to operate the brake booster actively with adjusting device 3, when the control unit is using signals for control which do not depend on the driver. What is imaginable is automatic emergency braking, braking interventions for distance control from preceding vehicles, or even functions such as a brake disk wiper.

In the operation of the braking system via input element 24, the driver generally experiences a reaction that includes different reactions, such as that of return springs 29, 28) and the reaction of the hydraulic brake system itself via main brake cylinder 2, piston rod 19, guidance part 21 and reaction disk 20.

During operation of adjusting device 27 at a changing braking effect of the regenerative brake system, the reaction of the hydraulic brake system changes. By the change in the supporting force of the brake booster, the change in the reaction of the hydraulic brake system can be hidden from the driver.

In this way, not only is the positioning of the input element able to be maintained, but it is also ensured that the driver always experiences the reaction he expects, in response to a present actuating position. Thus, the brake booster according to the present invention may be used not only as a controllable brake booster, but also in connection with the adjusting unit as a pedal sensory simulator during the masking of a generator torque in regenerative braking.

In all the specific embodiments shown, brake booster 1 and main brake cylinder 2 are shown having one and the same housing. This is not essential. The brake booster and the main brake cylinder may equally well have their own housing, and thus be present as separate components.

1-23. (canceled)

24. A vacuum brake booster which acts upon a main cylinder using a supporting force, the vacuum brake booster having an adjusting device for setting the supporting force, and a main control valve for setting the supporting force, wherein, in a first operating mode, the supporting force is set by the adjusting device and, in a second operating mode, the supporting force is set by the main control valve.

25. The vacuum brake booster as recited in claim 24, wherein the adjusting device is connected pneumatically to a first chamber of the vacuum brake booster and to the main control valve of the vacuum brake booster.

26. The vacuum brake booster as recited in claim 25, wherein the adjusting device is connected pneumatically to at least one of a second chamber of the vacuum brake booster and a vacuum source of the vacuum brake booster.

27. The vacuum brake booster as recited in claim 26, wherein the adjusting device includes:
a first interrupting element to interrupt a pneumatic connection of the adjusting device to surroundings; and
a second interrupting element to interrupt the pneumatic connection between the adjusting device and the main control valve;
wherein the first interrupting element is a currentless closed valve, and the second interrupting element is a currentless open valve.

28. The vacuum brake booster as recited in claim 27, wherein the first interrupting element is a continuously adjustable valve, and the second interrupting element is a switching valve.

29. The vacuum brake booster as recited in claim 26, wherein the adjusting device has a third interrupting element to interrupt the pneumatic connection of the adjusting device to the at least one of the second chamber of the brake booster and the vacuum source, the third interrupting element being a currentless closed valve.

30. The vacuum brake booster as recited in claim 27, wherein the vacuum brake booster has a first element to determine a position of an input element for taking up an operating force applied by a driver, and a second element to determine a position of a booster element with respect to a housing of the vacuum brake booster.

31. The vacuum brake booster as recited in claim 30, wherein the vacuum brake booster has an element to determine a relative deflection of an input element for taking up an actuating force applied by a driver and a booster element.

32. The vacuum brake booster as recited in claim 31, wherein the brake booster has an element to determine a differential pressure between the first chamber and a second chamber of the vacuum brake booster.

33. The vacuum brake booster as recited in claim 32, wherein the supporting force of the brake booster is set via a control unit, which controls at least the first and the second interrupting elements, while using signals of at least one of the first and the second elements for determining the position of the input element and the booster element, the element to determine the relative deflection of the input element and the booster element and the element to determine the differential pressure.

34. The vacuum brake booster as recited in claim 33, wherein the supporting force of the brake booster is set via a control unit, which controls at least the first and the second and the third interrupting elements.

35. The vacuum brake booster as recited in claim 25, wherein the vacuum brake booster has an element to connect the first chamber of the brake booster to a vacuum source in an interruptable manner, via a pneumatic connection that is interruptable using a fourth interrupting element.

36. A method for operating a vacuum brake booster which acts on a main cylinder using a supporting force, the vacuum brake booster having an adjusting device for setting the supporting force, and a main control valve for setting a supporting force, the method comprising:
setting, in a first operating mode of the brake booster, the supporting force during an interrupted pneumatic connection between the adjusting device and the main control valve by producing a pneumatic connection between surroundings and the adjusting device.

37. The method as recited in claim 36, wherein the supporting force applied during the interrupted pneumatic connection between the adjusting device and the main control valve is set by producing the pneumatic connection between one of surroundings and the adjusting device, or the adjusting device and a second chamber of one of the brake booster and a vacuum source.

38. The method as recited in claim 36, wherein at least one of the producing and the interrupting of the pneumatic connections takes place by control of a first and a second interrupting element.

39. The method as recited in claim 37, wherein the at least one of the producing and the interrupting of the pneumatic connections takes place by the control of the first, the second and a third interrupting element.

40. The method as recited in claim 36, further comprising:
determining the supporting force that is to be set at least one of while taking into account signals of a first and a second element to determine a position of an input element and a position of a booster element, and while using an element to determine a relative deflection of the input element and the booster element.

41. The method as recited in claim 36, further comprising:
determining the supporting force that is to be set while taking into account signals of an element to determine a differential pressure between a first chamber and a second chamber of the vacuum brake booster.

42. The method as recited in claim 36, wherein a relationship between the supporting force that is to be set and a position of an input element is specifiable in the form of at least one characteristic line in a control unit of the brake booster.

43. The method as recited in claim 36, wherein in a second operating mode, the pneumatic connection between the adjusting device and the main control valve is open, the first interrupting element being closed and the supporting force being set by actuating the main control valve, the second operating mode being in a case of a failure of the adjusting device.

44. The method as recited in claim 43, wherein in the second operating mode, a third interrupting element is closed.

45. The method as recited in claim 43, wherein the main control valve is actuated by the driver using muscle force of a driver.

46. The method as recited in claim 43, wherein the vacuum brake booster is a part of a hydraulic brake system of an overall brake system; the overall brake system having an additional subbrake system, in addition to a hydraulic subbrake system, wherein a braking effect of a hydraulic brake system is adjusted to a change of a braking effect of the additional subbrake system by setting the supporting force of the vacuum brake booster.

47. The method as recited in claim 36, wherein a first chamber of the brake booster in a nonactuated state is connected to a vacuum source via at least one of a fourth interrupting element and via a third interrupting element.
